(19) United States
(12) Patent Application Publication
(10) Pub. No.: US 2016/0295835 A1
(43) Pub. Date: Oct. 13, 2016

(54) PET AMUSEMENT SYSTEM

(71) Applicant: Pawbo Co., Ltd., New Taipei (TW)

(72) Inventors: CHE YUAN CHENG, Taichung (TW); HUNG CHIN HSIAO, New Taipei (TW)

(21) Appl. No.: 14/683,200

(22) Filed: Apr. 10, 2015

(51) Int. Cl. A01K 15/02

(52) U.S. Cl. CPC A01K 15/025

(57) ABSTRACT

A pet amusement system includes a controlling device having an image fetching unit, an amusing unit for amusing a pet, and a processing unit electrically connected to the amusing unit and the image fetching unit respectively; a transceiver; and a mobile device for activating the controlling device via the transceiver. The image fetching unit is a digital camera which can be activated by the processing unit.

### BACKGROUND OF THE INVENTION

1. Field of the Invention

The invention relates to amusement systems and more particularly to a system including a controlling device and a mobile device for activating the controlling device over the Internet so that the controlling device may entertain and amuse pets.

2. Description of Related Art

There is a conventional pet amusement device including a weighted base with a curved outer surface, and a fan within the base for directing airflow into a transparent viewing chamber which contains flying particles. The particles may be luminescent to glow in the dark. The device can appeal to the animal's stalking instincts and return to an upright position when pawed or struck.

While the device has been fully successful for its intended purpose, further improvements regarding pet amusement are still sought.

### SUMMARY OF THE INVENTION

It is therefore one object of the invention to provide a pet amusement system comprising a controlling device including an image fetching unit, an amusing unit for amusing a pet, and a processing unit electrically connected to the amusing unit and the image fetching unit respectively; a transceiver; and a mobile device for activating the controlling device via the transceiver; wherein the image fetching unit is a digital camera which is configured to be activated by the processing unit.

The above and other objects, features and advantages of the invention will become apparent from the following detailed description taken with the accompanying drawings.

### BRIEF DESCRIPTION OF THE DRAWINGS

FIG. 1 is a block diagram of a pet amusement system according to the invention;

FIG. 2 schematically depicts a first preferred embodiment of the pet amusement system of the invention;

FIG. 3 schematically depicts a second preferred embodiment of the pet amusement system of the invention;

FIG. 4 schematically depicts a third preferred embodiment of the pet amusement system of the invention; and

FIG. 5 schematically depicts a fourth preferred embodiment of the pet amusement system of the invention.

### DETAILED DESCRIPTION OF THE INVENTION

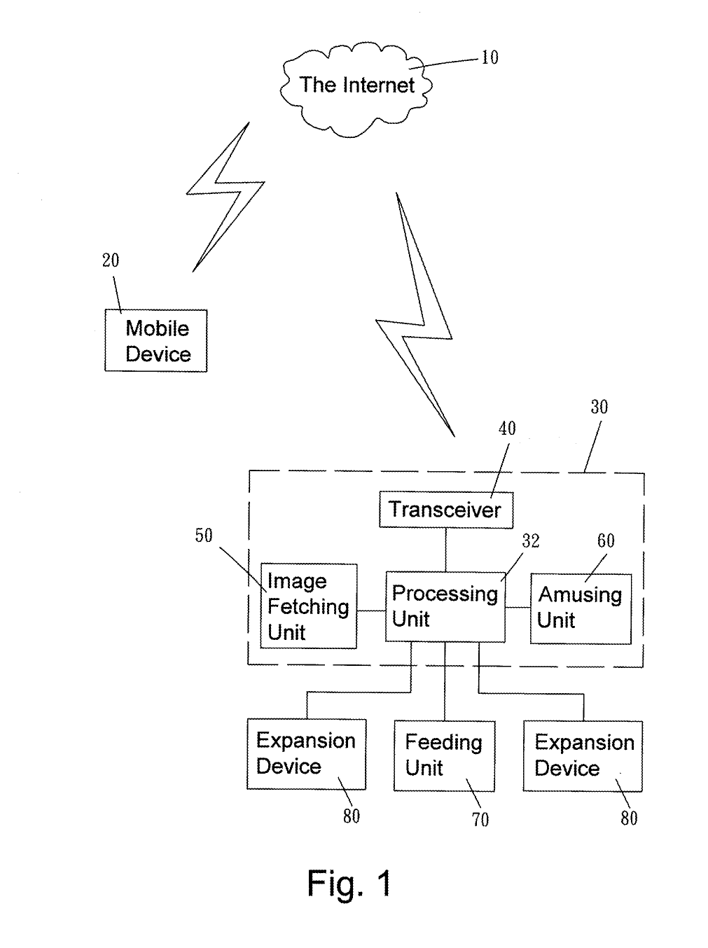

Referring to FIG. 1, a pet amusement system in accordance with the invention comprises the following components as discussed in detail below.

A mobile device 20 such as smart phone or iPad is provided. The mobile device 20 is capable of running mobile apps. It is noted that the term “app” is a shortening of the term “application software”. A controlling device 30 includes a processing unit 32. Further, a transceiver 40, an image fetching unit 50, and an amusing unit 60 are provided in the controlling device 30 in which the processing unit 32 is electrically connected to the transceiver 40, the amusing unit 60, and the image fetching unit 50 respectively. A person may operate the mobile device 20 to activate the controlling device 30 via the Internet 10. Two expansion devices 80 and a feeding unit 70 are provided externally of the controlling device 30. The feeding unit 70 is configured to feed food or water to a pet.

The processing unit 32 is capable of generating an identification result indicating whether there is a bark from a target pet. The transceiver 40 can receive a control signal from the mobile device 20 and/or send signals to the mobile device 20. The image fetching unit 50 is implemented as a digital camera capable of encoding digital images and videos of a pet, and storing the recoded images and videos in digital files, and sending them to the processing unit 32 to further process. The amusing unit 60 is implemented as a device for throwing a ball to be played by a pet dog, a remote control toy pet, a toy fish to be played by a pet cat, or a lamp.

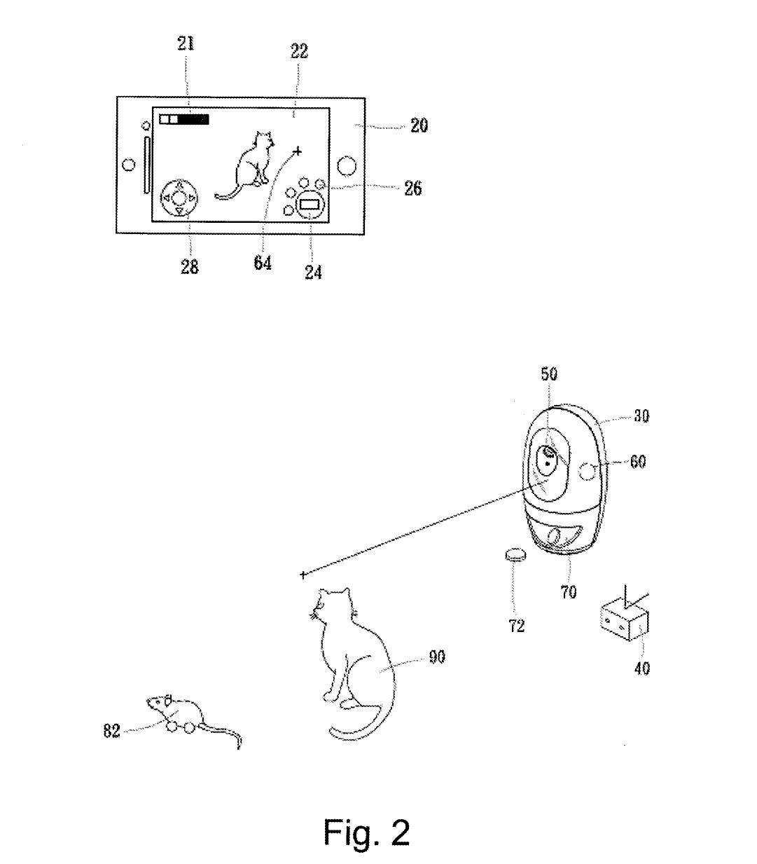

Referring to FIG. 2, a pet amusement system in accordance with a first preferred embodiment of the invention is shown. The characteristics of the first preferred embodiment are discussed below.

The mobile device 20 is implemented as a smart phone and includes a display (e.g., touchscreen) 22 for allowing a pet owner to interact directly with what is displayed. An app key 24, a plurality of function keys 26, a direction button 28, and a pet temper indicator 21 are provided on the display 22. A pet owner may press the app key 24 to run embedded software or the like. The direction button 28 contains up, down, left and right direction arrows for selection. A pet owner may press one of the function keys 26 to activate the controlling device 30 which then performs a corresponding function. Also, the controlling device 30 may be activated after the pet temper indicator 21 indicating a low value. The activated controlling device 30 then transmits a signal to the pet owner owning the mobile device 20. The signal is converted into a representation. Thus, the pet owner may be visually alerted by the representation to take care of the pet 90. The transceiver 40 is implemented as a base station externally of the controlling device 30. Signals transmitted from the mobile device 20 are received by the transceiver 40 via the Internet 10. The signals are then sent to the processing unit 32 for processing. The image fetching unit 50 can be activated by the processing unit 32 as a result of the processing. Images of a pet 90 are fetched by the image fetching unit 50 if the pet 90 is located within an image fetching range of the image fetching unit 50. Further, the images are processed by the processing unit 32. Furthermore, the processed images of the pet 90 are sent back to the mobile device 20 and shown on the display 22.

The pet owner may get the pet 90 within image fetching range of the image fetching unit 50 if the pet 90 is not in the range by performing the following two methods: The pet owner may call the mobile device 20 which broadcasts the call to the pet 90. Alternatively, the owner may run a pre-recorded audio file to broadcast a call to the pet 90.

The pet 90 may make sound. The processing unit 32 may compare the sound with a predetermined value. A comparison result is reflected by the pet temper indicator 21. The owner can determine temper of the pet 90 by viewing brightness of the boxes of the pet temper indicator 21. The owner may press one of the function keys 26 to activate the feeding unit 70 if the owner determines that the sound made by the pet 90 means hungry. As a result, food or water is supplied to the pet 90 for consumption.

The owner can determine that the pet 90 feels lonely by its sound. Then the owner can activate the controlling device 30 which emits light to impinge on the ground as indicated by a flashing point 64 on the display 22. The pet 90 may chase the flashing point 54. Further, images of the pet 90 chasing the flashing point 64 are shown on the display 22. This is similar to the owner playing with the pet 90 in person. Alternatively, the owner may activate a battery powered toy 82 as an implementation of the expansion device. Likewise, the owner may watch the pet 90 chasing or playing with the toy 82.

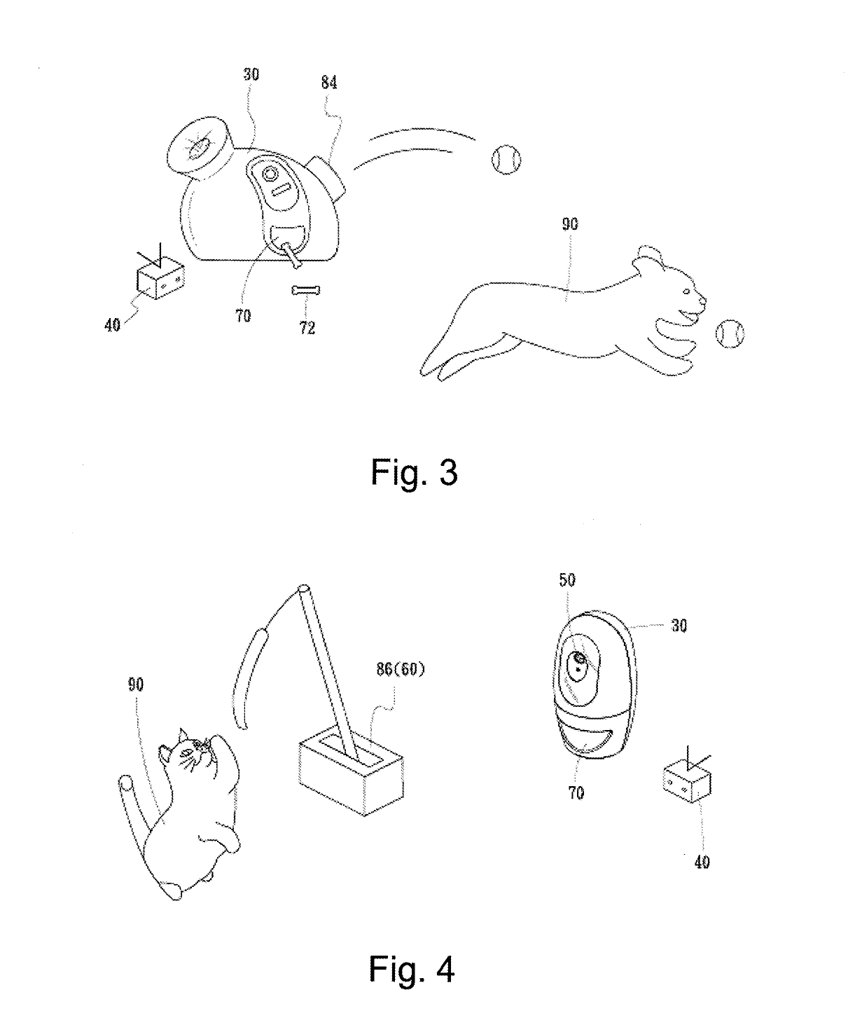

Referring to FIG. 3, a pet amusement system in accordance with a second preferred embodiment of the invention is shown. The characteristics of the second preferred embodiment are substantially the same as that of the first preferred embodiment except the following: The expansion device is implemented a ball throwing device 84 as a part of the controlling device 30. Balls thrown by the ball throwing device 84 are adapted to be chased or played by the pet (e.g., dog) 90. Further, the feeding unit 70 is activated to supply food 72 to be consumed by the pet 90.

Referring to FIG. 4, a pet amusement system in accordance with a third preferred embodiment of the invention is shown. The characteristics of the third preferred embodiment are substantially the same as that of the first preferred embodiment except the following: The amusing unit 60 is implemented as a device 86 for amusing a pet cat 90.

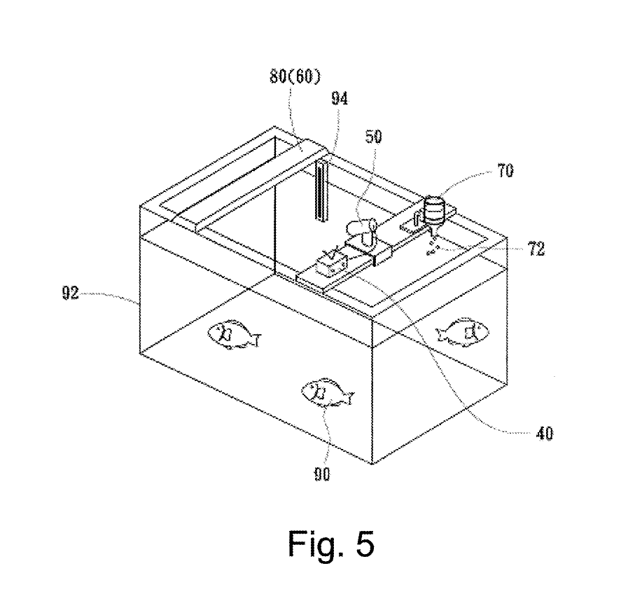

Referring to FIG. 5, a pet amusement system in accordance with a fourth preferred embodiment of the invention is shown. The characteristics of the fourth preferred embodiment are discussed below. The pet 90 is fish. The food 72 is for fish consumption only. The amusing unit 60 is implemented as a lamp 80. A thermometer 94 is mounted on an inner surface of the wall of an aquarium 92. The lamp 80 can be turned on to illuminate fish 90 swimming in the aquarium 92.

While the invention has been described in terms of preferred embodiments, those skilled in the art will recognize that the invention can be practiced with modifications within the spirit and scope of the appended claims.

What is claimed is:

1. A pet amusement system comprising:
a controlling device including an image fetching unit, an amusing unit for amusing a pet, and a processing unit electrically connected to the amusing unit and the image fetching unit respectively;
a transceiver; and
a mobile device for activating the controlling device via the transceiver;
wherein the image fetching unit is a digital camera which is configured to be activated by the processing unit.

2. The pet amusement system of claim 1, wherein the controlling device further comprises a feeding unit.
